(19) United States
(12) Patent Application Publication
(10) Pub. No.: US 2007/0211474 A1
(43) Pub. Date: Sep. 13, 2007

(54) Lampshade assembly

(76) Inventors: Chao-Chuan Chen, Taichung City (TW); Yun-Hui Tu, Taichung City (TW)

Correspondence Address: PHILLIP LIU, 6980, WHITEOAK DR., RICHMOND, BC, V7EAZ9, CA

(21) Appl. No.: 11/368,499

(22) Filed: Mar. 7, 2006

(51) Int. Cl. F21V 11/00

(52) U.S. Cl. 362/351

(57) ABSTRACT

A lampshade assembly includes a cup-shaped first part and a cup-shaped second part. The first part has a plurality of protrusions and the second part has a plurality of engaging holes so that the first part can be connected to the second part by extending the protrusions through the engaging holes. The first part is a semi-transparent member and the second part includes apertures defined therethrough so that light beams pass through the apertures to have a special lighting feature.

### FIELD OF THE INVENTION

The present invention relates to a lampshade assembly including a first part and a second part which can be connected to the first part in different ways.

### BACKGROUND OF THE INVENTION

A conventional lampshade generally includes a fixed shape and cannot only be used as a shade. Typically, the conventional lampshade includes a top ring, a bottom ring and a plurality of ribs connected between the top and bottom rings. A piece of cloth is mounted on the ribs and the two rings to form the lampshade. By the lampshade, people do not see the light beams of the lamp directly and the lamp is enclosed by the lampshade so that people are not burned by the hot lamp. Some lampshades are designed to be foldable and detachable so that the lampshades occupy less space when in transportation, such as the lampshades disclosed in U.S. Pat. Nos. 6,883,939, 6,851,836, and 6,773,144. Nevertheless, these conventional lampshades still has a fixed function.

The present invention intends to provide a lampshade assembly which includes two parts which are connected to each other in different ways so as to obtain variable combinations of the lampshade.

### SUMMARY OF THE INVENTION

The present invention relates to a lampshade assembly which comprises a first part having a plurality of holes defined therethrough so that an electrical cable extends therethrough, and a second part which has a plurality of apertures defined therethrough. A plurality of protrusions extend from the first part and a plurality of engaging holes are defined in the second part. The protrusions are engaged with the engaging holes so as to connect the first part to the second part. Light beams from the lamp in the lampshade pass through the through holes in the second part.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the lampshade assembly of the present invention, wherein the first part and the second part face the same direction;

FIG. 2 is an exploded view to show the lampshade assembly of the present invention, wherein the first part and the second part face two opposite directions;

FIG. 3 shows light beams pass through the through holes in the second part;

FIG. 4 shows the lampshade assembly is used to a pendant, wherein the second part faces the floor;

FIG. 5 shows the lampshade assembly is used to lamp put on the floor;

FIG. 6 shows the lampshade assembly is used to a wall lamp;

FIG. 7 shows the lampshade assembly is used to a pendant while the first part faces the floor, and

FIG. 8 shows the lampshade assembly is used to a floor lamp.

### DETAILED DESCRIPTION OF THE PREFERRED EMBODIMENT

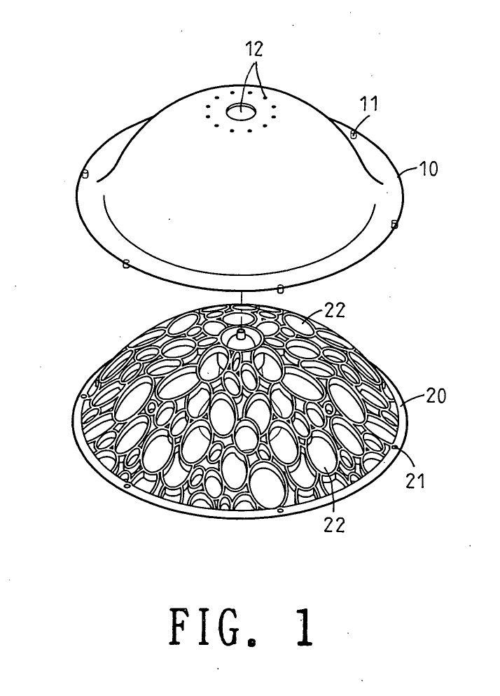

Referring to FIG. 1, the lampshade assembly of the present invention comprises a first part 10 which is a cup-shaped member and made by semi-transparent material. The first part 10 has a plurality of holes 12 defined through a central portion thereof. A second part 20 is a cup-shaped member and has a plurality of apertures 22 defined therethrough. A connection device connects the first part 10 to the second part 20 to form different types of lampshade combinations.

The connection device includes a first flange extending from a periphery of the first part 10 and a plurality of protrusions 11 extend from the first flange. The second part 20 has a second flange extending from a periphery thereof and a plurality of engaging holes 21 are defined 11 through the second flange. The protrusions 11 are engaged with the engaging holes 21 to combine the first and second parts 10, 20.

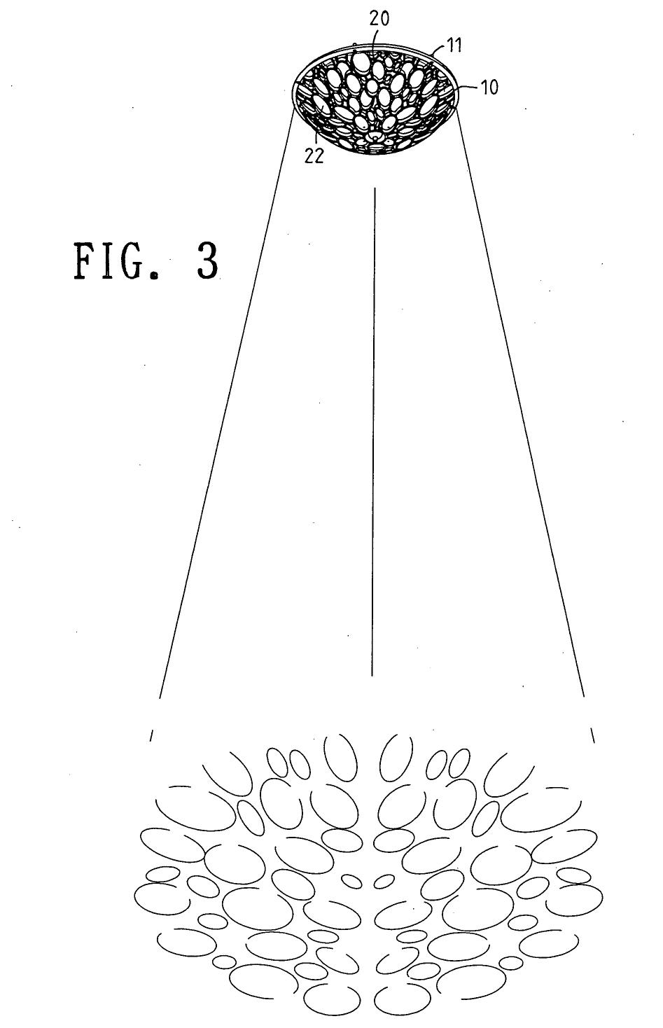

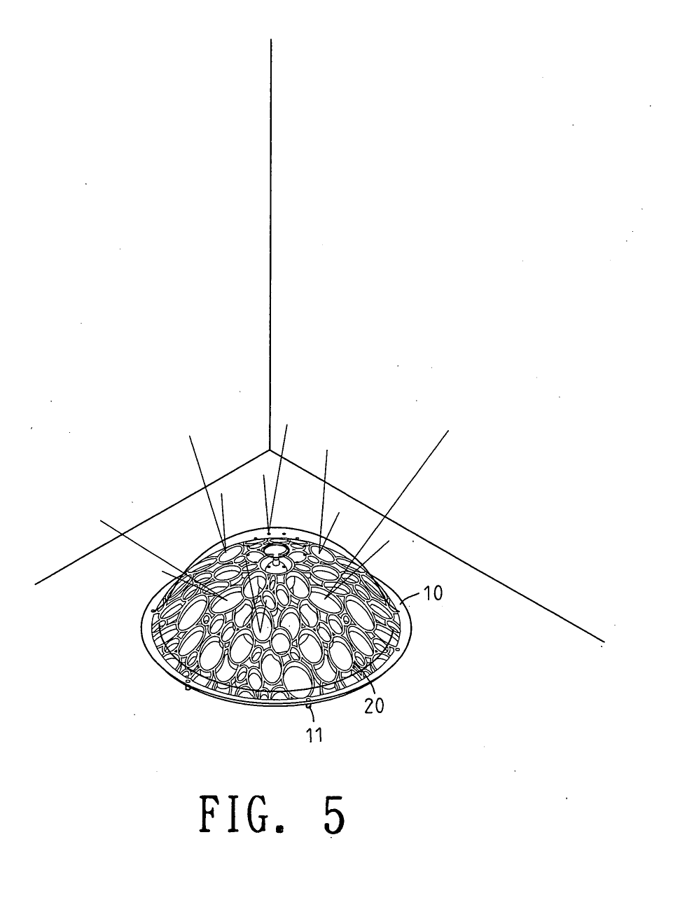

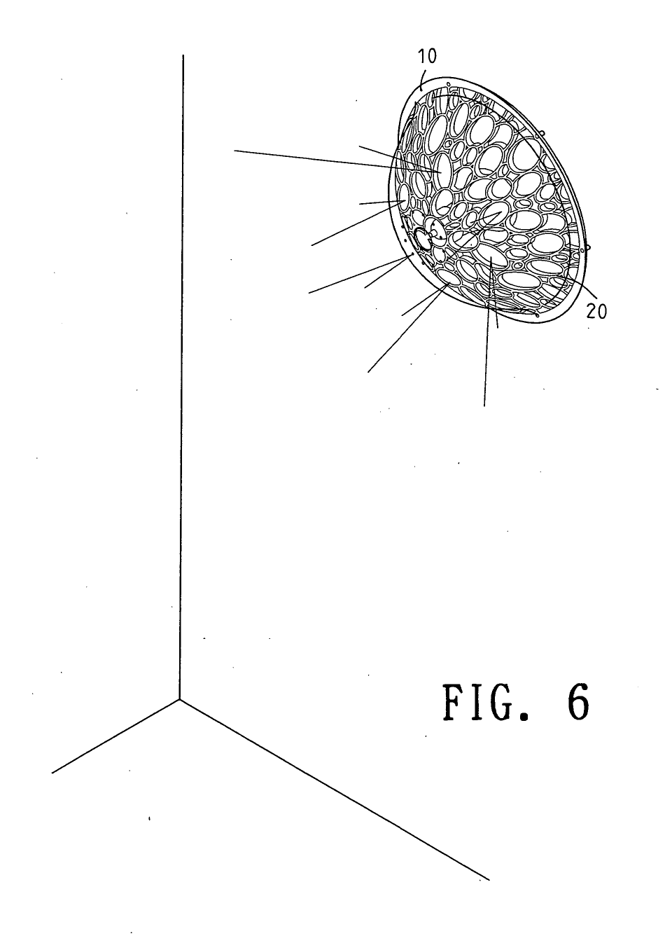

The first combination of the first and second parts 10, 20 is that the convex side of the second part 20 is engaged with the concave side of the first part 10, and the lamp (not shown) is located in the concave side of the first part 10 so that the light beams go through the apertures 22 as shown in FIG. 3. As shown in FIG. 5, the lampshade assembly can be put on the floor and the second part 20 is mounted on the first part 10, the protrusions 11 extend through the engaging holes 21 and protrude beyond the flange of the second part 20 so that the lampshade assembly can be supported on the protrusions 11. As shown in FIG. 6, the lampshade assembly can be a wall lamp with the protrusions 11 connected to the wall.

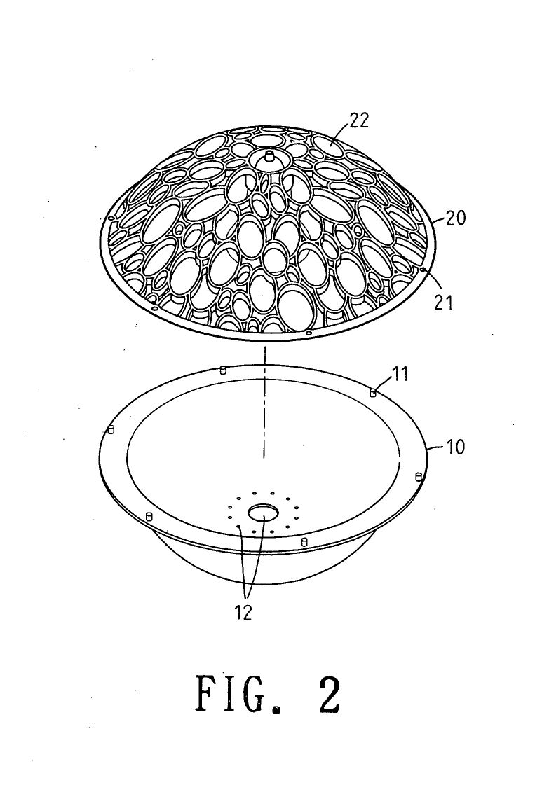

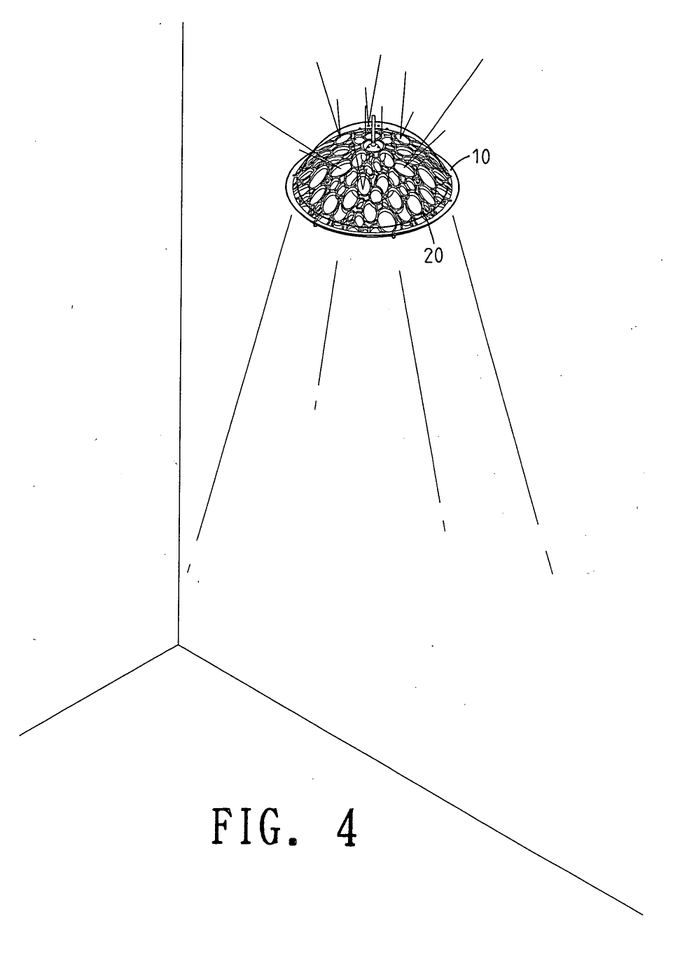

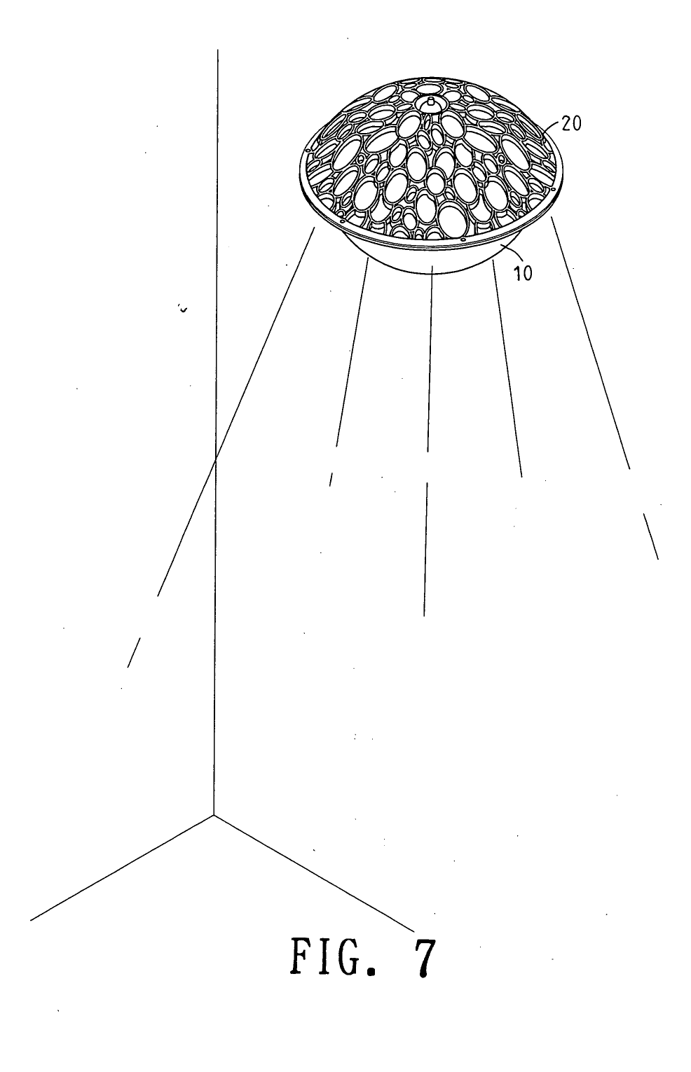

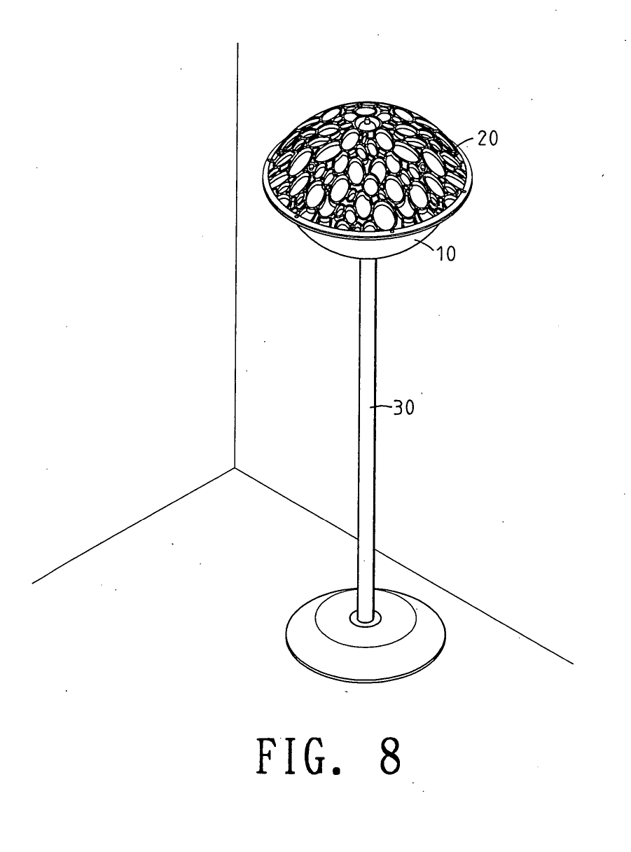

As shown in FIG. 2, the second combination of the first and second parts 10, 20 is that the two respective convex sides of the first part 10 and the second part 20 are located at remote ends of the combination, the first and second flanges are connected with each other with the protrusions 11 extending through the engaging holes 21. FIG. 4 shows that the lampshade assembly is used to a pendant wherein the electrical cable extends through one of the holes 12 in the first part 10 and light beams go through the apertures 22 of the second part 20. FIG. 7 shows that the pendant can be used such that the first part 10 faces the floor and the second part 20 faces the ceiling. FIG. 8 shows a floor lamp wherein the post 30 extends into the first part 10 via one of the holes 12 and the second part 20 faces the ceiling.

While we have shown and described the embodiment in accordance with the present invention, it should be clear to those skilled in the art that further embodiments may be made without departing from the scope of the present invention.

What is claimed is:

1. A lampshade assembly comprising:
a first part having a plurality of holes defined therethrough;
a second part having a plurality of apertures defined therethrough, and
a connection device connecting the first part to the second part.

2. The lampshade assembly as claimed in claim 1, wherein the connection device includes a plurality of protrusions extending from the first part and a plurality of engaging holes defined in the second part, the protrusions are engaged with the engaging holes.

3. The lampshade assembly as claimed in claim 2, wherein the first part has a first flange extending from a periphery thereof and the protrusions extend from the first flange, the second part has a second flange extending from a periphery thereof and the engaging holes are defined through the second flange.

4. The lampshade assembly as claimed in claim 1, wherein the first part and the second part each are is a cup-shaped member and a convex side of the second part is engaged with a concave side of the first part.

5. The lampshade assembly as claimed in claim 2, wherein the protrusions extend through the engaging holes and protrude beyond the flange of the second part.

6. The lampshade assembly as claimed in claim 1, wherein the first part is made by semi-transparent material.
